(19) United States
(12) Patent Application Publication
(10) Pub. No.: US 2026/0018821 A1
(43) Pub. Date: Jan. 15, 2026

(54) ELECTRICAL CONNECTOR

(71) Applicants: FUDING PRECISION COMPONENTS (SHENZHEN} CO, LTD., Shenzhen (CN); FOXCONN INTERCONNECT TECHNOLOGY LIMITED, Grand Cayman (KY)

(72) Inventors: YU-HUANG ZHAO, Shenzhen (CN); WEI-JEN LIAO, New Taipei (TW); MING-LUN SZU, New Taipei (TW); JIA-HAU LIU, New Taipei (TW)

(21) Appl. No.: 19/265,424

(22) Filed: Jul. 10, 2025

(30) Foreign Application Priority Data
Jul. 10, 2024 (CN) 202410920641.2

(51) Int. Cl. H01R 13/432; H01R 13/6586; H01R 13/6596

(52) U.S. Cl. CPC H01R 13/432; H01R 13/6586; H01R 13/6596

(57) ABSTRACT

An electrical connector includes an insulating housing and plural terminal rows. The insulating housing has an upper face, a lower face, and a terminal slot. Each of the terminals of the plural terminal rows is formed by stamping a metal plate and includes a base portion fixed in the terminal slot, an upper resilient arm, and a lower resilient arm. The base portion includes two metal faces opposite each other, a left cut face and a right cut face opposite each other, and an upper cut face and a lower cut face opposite each other. The upper resilient arm sequentially includes an upper portion extending upward from the upper cut face, a horizontal portion, and an upper abutting portion extending downward from an end of the horizontal portion. Each of the terminals of the plural terminal rows further includes an upper contact portion protruding upward from the horizontal portion.

### BACKGROUND OF THE INVENTION

### Field of the Invention

The present invention relates to an electrical connector.

### Description of Related Arts

China Patent CN212412342U discloses an electrical connector including multiple signal terminals arranged in rows in a longitudinal direction and ground shield plates each extending in a horizontal or a longitudinal direction. The ground shield plates extending in the horizontal direction are each formed with an upper resilient portion. The signal terminals are each formed with a respective upper bend portion. The upper resilient portion can be formed by cutting but the upper bend portion must be formed by bending. The shapes of these two are significantly different such that methods for forming the two are also significantly different, thus complicating the method for forming the terminals.

Therefore, it is necessary to provide an electrical connector with an improved structure to overcome the above deficiency.

### SUMMARY OF THE INVENTION

An electrical connector comprises: an insulating housing having an upper face, a lower face, and a plurality of terminal slots passing through the upper face and the lower face; a plurality of terminal rows each arranged in a first direction and having at least one terminal, the terminal rows arranged side by side in a second direction, each of the terminals of the plurality of terminal rows being formed by stamping and comprising a base portion fixed at a corresponding terminal slot and an upper resilient arm and a lower resilient arm both extending from the base portion, wherein: the base portion comprises two metal faces opposite each other, a left cut face and a right cut face opposite each other, and an upper cut face and a lower cut face opposite each other; the upper resilient arm extends from a part of the upper cut face proximal to the left cut face and out of the upper face of the insulating housing, the upper resilient arm sequentially comprises an upper extending portion, a horizontal portion, and an upper abutting portion, the upper extending portion extending upward from the upper cut face, the horizontal portion bending and extending in a horizontal direction from an end of the upper extending portion, the upper abutting portion extending downward from an end of the horizontal portion; and each of the terminals of the plurality of terminal rows comprises an upper contact portion protruding upward from the horizontal portion.

An electrical connector comprises: an insulating housing having an upper face, a lower face, and a long slot and a terminal slot passing through the upper face and the lower face; at least one signal terminal row having a signal terminal and being arranged in a first direction, the signal terminal being fixed in the terminal slot; and two ground terminal rows arranged at two sides of the signal terminal row and each having a plurality of ground terminals, wherein each of the signal terminal and the ground terminals comprises an upright base portion, an upper resilient arm extending upward from the base portion and having an upper contact portion, and an upper abutting portion positioned at an end of the upper resilient arm for contacting the base portion, the ground terminals and the signal terminal have a same height in a vertical direction and each have an upper resilient arm, at least a portion of the ground terminals in the same row forms an integrated ground plate connecting respective base portions, and the integrated ground plate is positioned in the long slot.

An electrical connector comprises: at least two ground terminals being substantially parallel to each other and each having a base portion, a through slot formed at the base portion, and a contact portion arranged in the through slot; at least one signal terminal substantially parallel to the ground terminals and arranged between the at least two ground terminals; and a grounding member engaging the at least two ground terminals, wherein the grounding member passes through the through slots of the at least two ground terminals and engages the at least two ground terminals by contacting the contact portions of the at least two ground terminals.

### BRIEF DESCRIPTION OF DRAWINGS

FIG. 1 is a perspective view of an electrical connector according to a first embodiment of the present disclosure;

FIG. 2 is a partial top view of the electrical connector shown in FIG. 1;

FIG. 3 is a perspective view of a portion of a terminal array of the electrical connector shown in FIG. 1;

FIG. 4 is a perspective view of a signal terminal in the terminal array shown in FIG. 3;

FIG. 5 is another perspective view of the signal terminal of FIG. 4;

FIG. 6 is a perspective view of a ground terminal plate in the terminal array shown in FIG. 3;

FIG. 7 is another perspective view of the ground terminal shown in FIG. 6;

FIG. 8 is a partial perspective view of an electrical connector according to a second embodiment of the present disclosure, wherein a part of the insulating housing of the electrical connector is removed;

FIG. 9 is a perspective view of a ground terminal plate shown in FIG. 8;

FIG. 10 is a perspective view of a portion of terminals according to a third embodiment of the present disclosure, wherein a grounding member is connected to ground terminals and passes through signal terminals;

FIG. 11 is a perspective view of a portion of terminals according to a fourth embodiment of the present disclosure, wherein a grounding member is connected to ground terminals and passes through signal terminals;

FIG. 12 is a perspective view of a portion of terminals according to a third embodiment of the present disclosure, wherein a grounding member is connected to ground terminals and passes through signal terminals;

FIG. 13 is a perspective view of a portion of a terminal array according to a sixth embodiment of the present disclosure;

FIG. 14 is a perspective view of a ground terminal plate in the terminal array of FIG. 13; and

FIG. 15 is a perspective view of a portion of terminals according to a seventh embodiment of the present disclosure, wherein a grounding member is connected to one ground terminal.

### DETAILED DESCRIPTION OF THE DRAWINGS

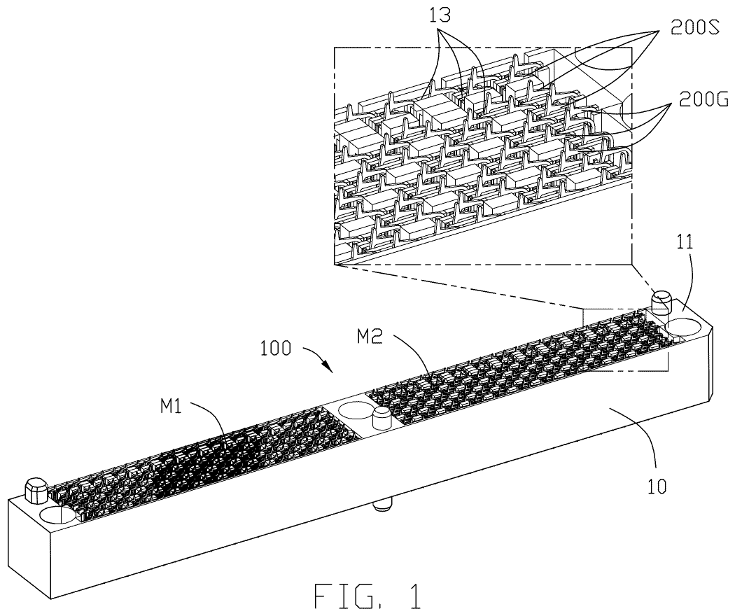

Referring to FIGS. 1-3, an electrical connector 100 according to a first embodiment of the present disclosure is configured to electrically connect a corresponding unit (such as a chip module) to a circuit board. The electrical connector 100 includes an insulating housing 10 and rows of terminals 20 arranged into array. Of particular note, the amount of terminals for the electrical connector 100 is high, possibly in the thousands, and to facilitate arrangement of the terminals, the terminals 20 can form a plurality of array modules. FIG. 1 shows an electrical connector having tow array modules M1 and M2. The two array modules M1 and M2 are arranged in a longitudinal direction. The following describes one of the array modules. Each row of terminals 20 is arranged in a first direction (longitudinal direction). The rows of terminals 20 are arranged side by side in a second direction (a horizontal direction perpendicular to the longitudinal direction). The insulating housing 10 has an upper face 11, a lower face 12, and a terminal slot 13 passing through the upper face 11 and the lower face 12.

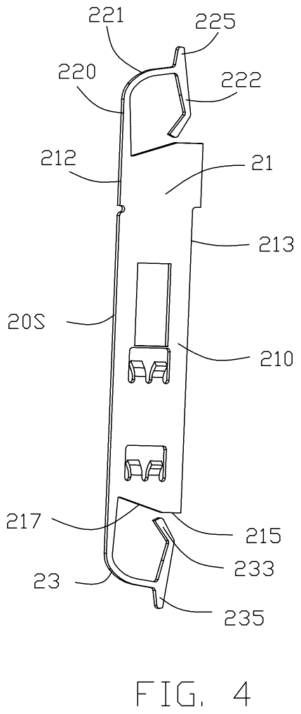

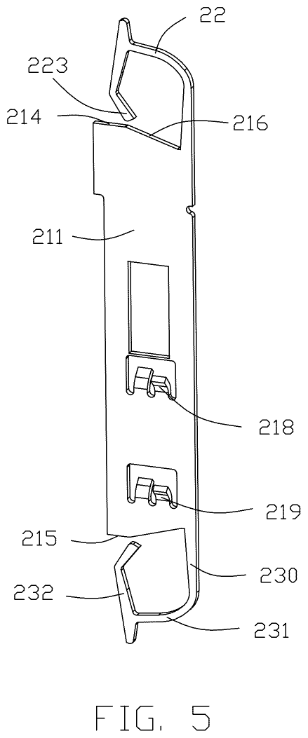

Referring to FIGS. 4-5, each of the terminals 20 is formed by stamping metal plates. Each of the terminals 20 includes a base portion 21 fixed in the terminal slot, and an upper resilient arm 22 and a lower resilient arm 23 extending from the base portion 21. The base portion 21 includes two metal faces 210, 211 opposite each other, a left cut face 212 and a right cut face 213 opposite each other, and an upper cut face 214 and a lower cut face 215 opposite each other. The upper resilient arm 22 extends from a part of the upper cut face 214 proximal to the left cut face 212, upwards to the upper face 11 of the insulating housing 10. The upper resilient arm 22 sequentially includes an upper extending portion 220, a horizontal portion 221, and an upper abutting portion 222. The upper extending portion 220 extends upward from the upper cut face 214. The horizontal portion 221 bends and extends horizontally from an end of the upper extending portion 220. The upper abutting portion 222 extends downward from an end of the horizontal portion 221. The terminal 20 further includes an upper contact portion 225, formed by protruding upward from the horizontal portion 221. Preferentially, the upper contact portion 225 protrudes and extends upward from an end of the horizontal portion 221. A free end of the upper abutting portion 222 inclines toward the upper extending portion 220. Namely, the free end of the upper abutting portion 222 has an inclined portion 223 inclining toward the upper extending portion 220. The upper cut face 214 has an inclined face 216 for engaging the inclined portion 223. Thus in the present disclosure, the terminal is positioned within a same plate. Understandably, in other embodiments of the present disclosure, the free end of the upper abutting portion 222 can bend slightly toward one of the metal faces 210, 211 at a side of the base portion 21, such that when abutted the free end of the upper contact portion 222 can contact the corresponding metal face 210, 211. Namely, a contact face for engaging the upper abutting portion 222 is positioned at a side of the base portion 21, and this type of deformation is a way of forming the terminals 20 through stamping according to the present disclosure, where the terminal 20 is positioned within a same plate.

Referring to FIGS. 4-5, the lower resilient arm 23 extends from a part of the lower cut face 215 proximal to the left cut face 212, downwards to the lower face 12 of the insulating housing 10. The lower resilient arm 23 sequentially includes a lower extending portion 230, a horizontal portion 231, and a lower abutting portion 232. The lower extending portion 230 extends downward from the lower cut face 215. The horizontal portion 231 bends and extends horizontally from an end of the lower extending portion 230. The lower abutting portion 232 extends upward from an end of the horizontal portion 231. The terminal 20 further includes a lower contact portion 235, formed by protruding downward from the horizontal portion 231. A free end of the lower abutting portion 232 inclines toward the lower extending portion 230. Namely, the free end of the lower abutting portion 232 has an inclined portion 233 inclining toward the lower extending portion 230. The lower cut face 215 has an inclined face 217 for engaging the inclined portion 233.

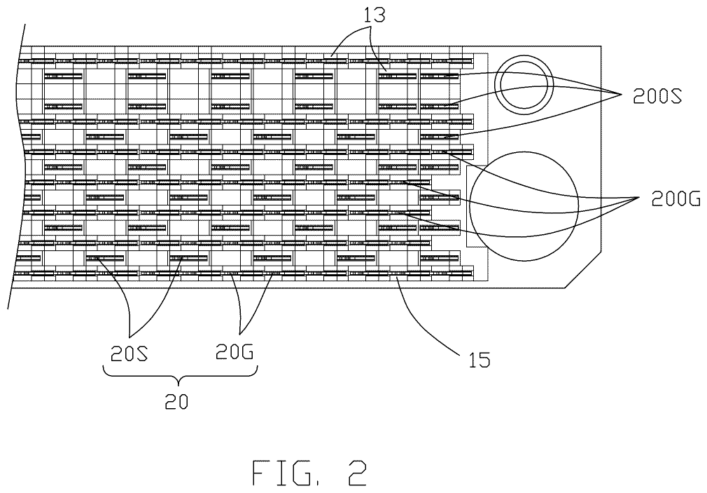

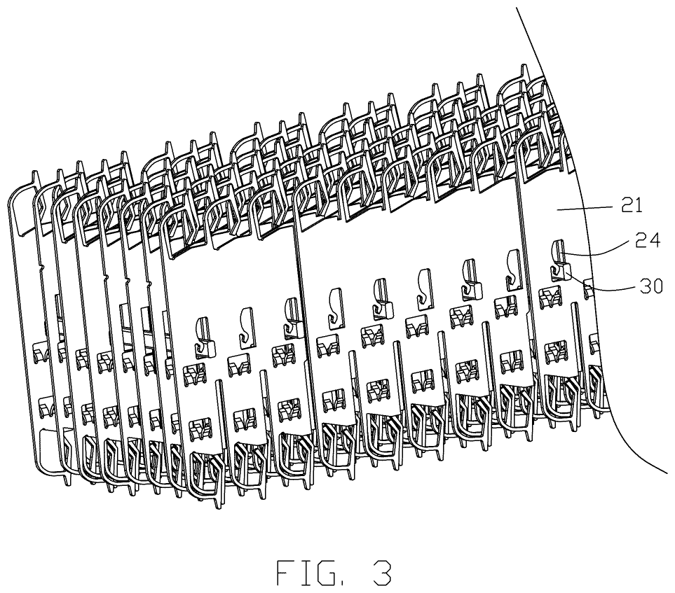

Referring to FIGS. 2-3, the terminals 20 include signal terminals 20S and ground terminals 20G. Terminal rows include first terminal rows (signal terminal rows) 200S formed by a plurality of signal terminals 20S, and second terminal rows (ground terminal rows) 200G formed by a plurality of ground terminals 20G. In the signal terminal rows 200S, the signal terminals 20S are independent of each other. In the ground terminal rows 200G, at least some of the neighboring ground terminals 200G are integrally connected at their left and right cut faces, forming a ground plate integrated as one body. The ground plate is positioned in a long slot 15 formed at the insulating housing 10. For achieving better shielding for the signal terminals 20S, in the second direction, two opposite sides of each of the signal terminal rows 200S each have one of the ground terminal rows 200G arranged thereat. Referring to FIG. 4-5, for securely holding the terminals 20 in the terminal slot, each of the base portion 21 has two first protruding ears 218 formed by stamping. The first protruding ears 218 protrudes respectively toward opposite directions, and from the metal faces at two sides of the base portion 21. Additionally, the base portion 21 has two second protruding ears 219 formed by stamping. Similar to the first protruding ears 218, the second protruding ears 219 also protrude respectively toward opposite directions, and from the metal faces at two sides of the base portion 21. The first protruding ears 218 are positioned above the second protruding ears 219, and the second protruding ears 219 is proximal to the lower cut face 215.

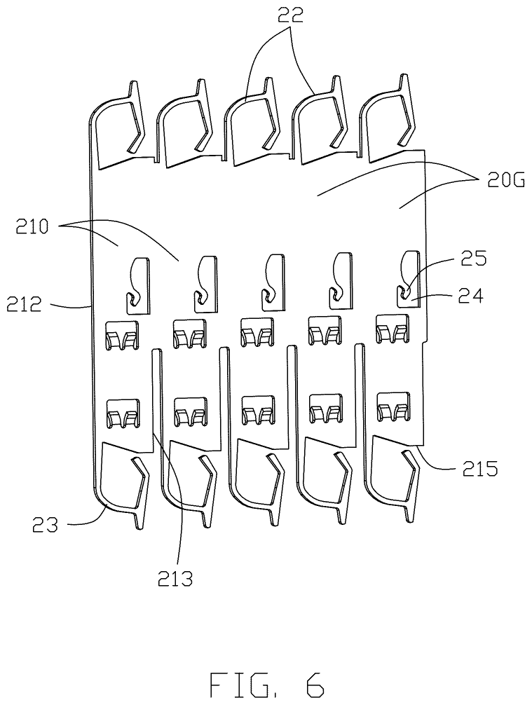

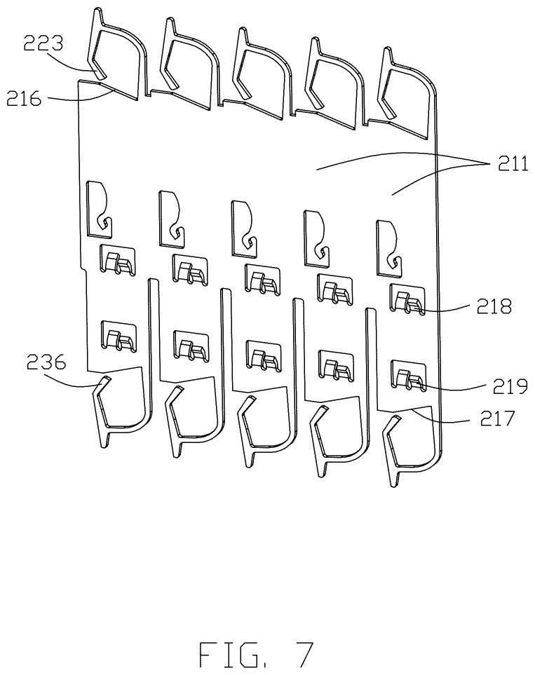

Referring to FIGS. 3-7, through the above description, it can be understood that the ground terminals 20G are integrally connected in a longitudinal direction to left or right cut faces of neighboring ground terminals 20G, forming the ground plate formed integrated as one body. In order to achieve better shielding for the signal terminals 20S, in a horizontal direction perpendicular to the longitudinal direction, the ground terminals positioned at different rows can be connected through grounding members 30. In the present embodiment, preferentially, in the longitudinal direction the grounding members 30 successively passes through the ground terminals 20G. Each of the grounding members 30 can be a strip-shaped metal plate or a metal rod. Additionally, in order to achieve good electrical connection between the grounding member 30 and the ground terminals 20G as the grounding member 30 passes through the ground terminals 20G, each of the ground terminals 20G has a through slot 24 for the grounding member 30 to pass through. The through slot 24 is formed with a contact portion 25. Preferentially, in the present embodiment, the contact portion 25 is a resilient member, resiliently abutting the grounding member 30 in the through slot 24. Preferentially, the resilient member is an elastic member having a curved shaped formed by stamping.

Referring to FIGS. 4-7, in the present embodiment, each of the signal terminals 20S and the ground terminals 20G include the upright extending base portion 21. The upper resilient arm 22 extends upward from the base portion 21 and has the upper contact portion 225. The upper abutting portion 222 is positioned at the end of the upper resilient arm 22 for contacting the base portion 21. The ground terminal 20G and the signal terminal 20S have a same height in a vertical direction and have the same upper resilient arm 22. At least a portion of the ground terminals 20G in a same row have connected base portions 21 and form an integrated ground plate and are positioned in the long slot 15. In the present disclosure, a height h of the terminal is greater than or equal to 7 mm, and is preferentially 7.6 mm. In the present disclosure the signal terminals 20S and the ground terminals 20G are produced mainly through stamping, in contrast to conventional techniques of producing the ground terminals mainly through cutting and producing the signal terminals through two steps of cutting and bending. Given that the upper resilient arms of the signal terminal and the ground terminal are similar, supporting forces of these two are also similar. A connected chip positioned above the connector is subject to balanced forces at multiple points, increasing the stability. Additionally, given that the height of the terminal 20 of the present disclosure is no less than 7 mm, the terminal 20 is difficult to create by conventional techniques for producing signal terminals. Namely, ensuring precision of the terminal 20 after cutting and bending is difficult. Therefore, the production method of the terminal 20 of the present disclosure is simpler.

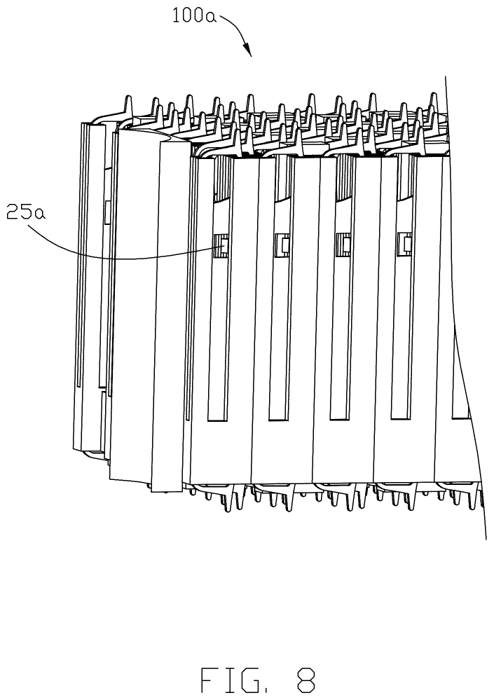

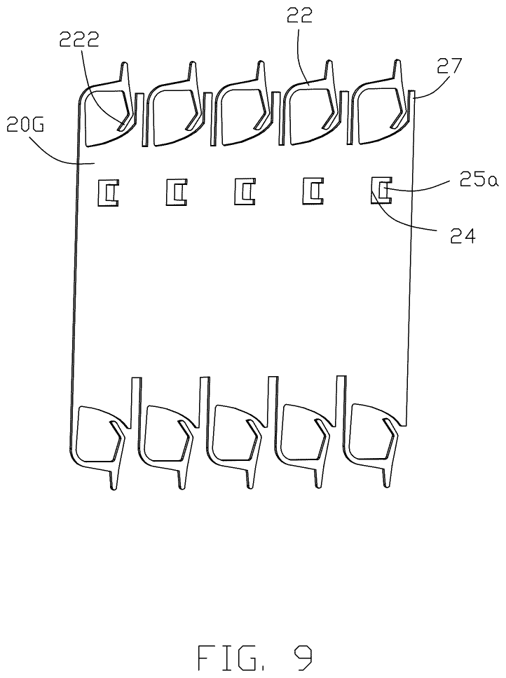

Referring to FIGS. 8-9, an electrical connector 100a of a second embodiment of the present disclosure is similar to the electrical connector 100 of the first embodiment. In the present embodiment, similar structures are labeled by the same numbers, and are not further described. The following mainly describes the differences. In the present embodiment, the base portion 21 of the ground terminal 20G also has a through slot 24 and a contact portion 25a positioned at the through slot 24. In the present disclosure, the contact portion 25a is also a resilient member, but has a shape different from that of the first embodiment. The resilient member of the present embodiment is a bent resilient member formed by tearing and bending. Additionally, different from the first embodiment, the terminal 20 has a carrier connecting portion 27 positioned at the right side of the upper resilient arm 22. Additionally, the inclined face 216a for engaging the inclined portion 223 of upper abutting portion 222 is slightly different from the above embodiment. The inclined face 216a inclines upward from the upper extending portion 220 and extends to the carrier connecting portion 27 at the right side.

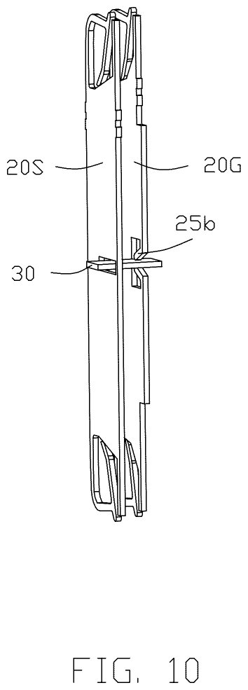

In a third embodiment of the present disclosure, the resilient member can have another form. As shown in FIG. 10, the contacting portion 25b is two clamp arms arranged symmetrically in a vertical direction. The grounding member 30 is clamped between the two clamp arms. The other structures are similar to those of the first embodiment and are not further described herein.

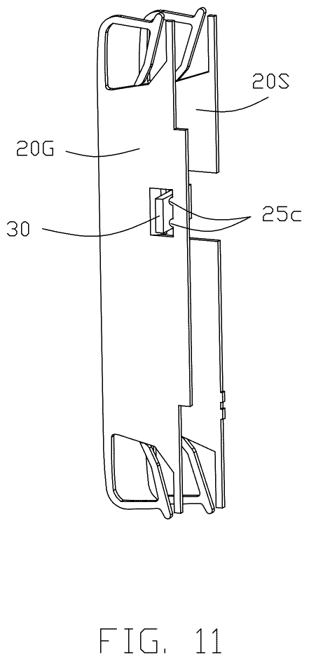

In a fourth embodiment of the present disclosure, referring to FIG. 11, the contact portion 25c includes at least one protruding rib arranged in the through slot. The amount of ribs can be determined according to need, such as one or multiple ribs. The other structures are similar to those of the first embodiment and are not further described herein.

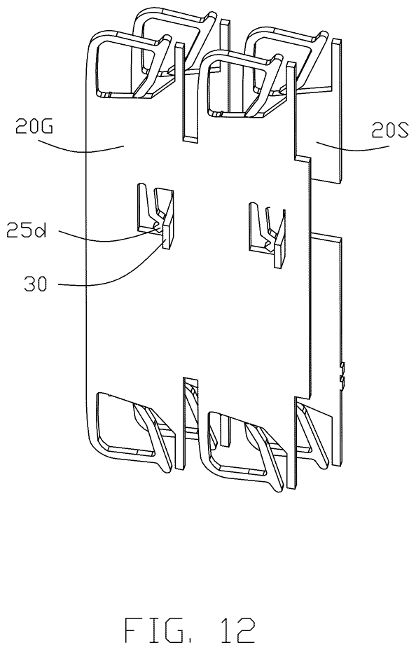

In a fifth embodiment of the present disclosure, referring to FIG. 12, the contact portion 25d is a hook shaped resilient member. The other structures are similar to those of the first embodiment and are not further described herein.

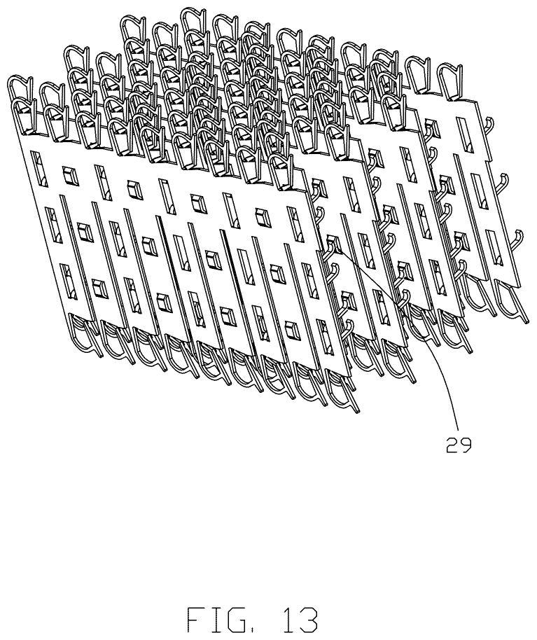

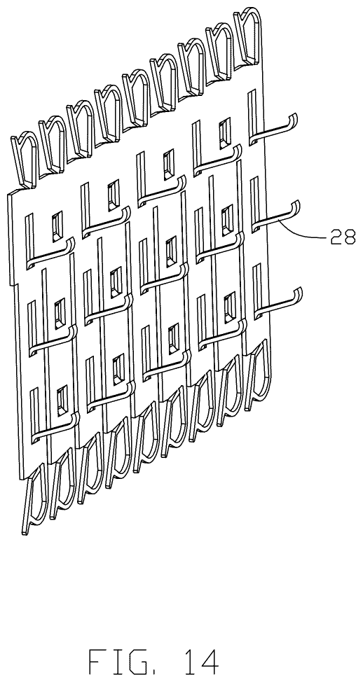

In a sixth embodiment of the present disclosure, ground plates of neighboring rows can be connected by other methods. Referring to FIGS. 13-14, the ground terminal 20G has a connecting leg 28 extending toward and abutting a corresponding neighboring ground terminal 20G. Preferentially, the connecting leg 28 abuts the base portion 21 of the corresponding ground terminal 20G.

Preferentially, the base portion 21 has a resilient protrusion 29 for engaging the connecting leg 28. A free end of the connecting leg 28 abuts the corresponding resilient protrusion 29, achieving electrical connection between the two ground terminals 20G. The resilient protrusion 29 can be formed by stamping the terminal. The other structures are similar to those of the first embodiment and are not further described herein.

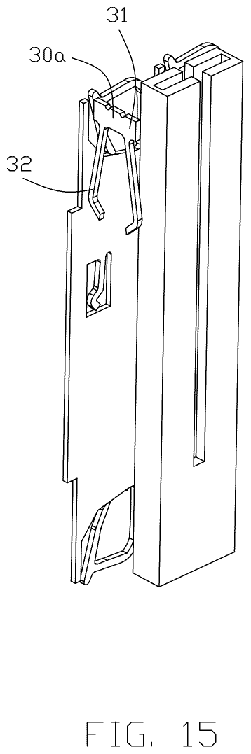

In a seventh embodiment of the present disclosure, ground plates of neighboring rows can be connected by other methods. Referring to FIG. 15, the grounding member 30a is inserted in a longitudinal direction between two corresponding ground terminals 20G of two neighboring rows in a longitudinal direction, for connecting the two corresponding ground terminals 20G. Each of the grounding member 30a includes a main body 31 extending in the longitudinal direction. Two resilient abutting arms 32 extend respectively from two ends of the main body 31 toward two corresponding ground terminals. Thereby, connection between plural ground terminals 20G can be achieved by arranging one grounding member 30a between two corresponding ground terminals 20G of two neighboring rows. The other structures are similar to those of the first embodiment and are not further described herein.

The above-mentioned embodiments are only preferred embodiments of the present disclosure, and should not limit the scope of the present disclosure, any simple equivalent changes and modifications made according to the claims of the present disclosure and the contents of the description should still belong to the present disclosure.

1. An electrical connector comprising:
an insulating housing having an upper face, a lower face, and a plurality of terminal slots passing through the upper face and the lower face;
a plurality of terminal rows each arranged in a first direction and having at least one terminal, the terminal rows arranged side by side in a second direction, each of the terminals of the plurality of terminal rows being formed by stamping and comprising a base portion fixed at a corresponding terminal slot and an upper resilient arm and a lower resilient arm both extending from the base portion; wherein
the base portion comprises two metal faces opposite each other, a left cut face and a right cut face opposite each other, and an upper cut face and a lower cut face opposite each other;
the upper resilient arm extends from a part of the upper cut face proximal to the left cut face and out of the upper face of the insulating housing, the upper resilient arm sequentially comprises an upper extending portion, a horizontal portion, and an upper abutting portion, the upper extending portion extending upward from the upper cut face, the horizontal portion bending and extending in a horizontal direction from an end of the upper extending portion, the upper abutting portion extending downward from an end of the horizontal portion; and
each of the terminals of the plurality of terminal rows comprises an upper contact portion protruding upward from the horizontal portion.

2. The electrical connector according to claim 1, wherein the plurality of terminal rows comprises a first terminal row, and the terminals in the first terminal row are independent and from signal terminals.

3. The electrical connector according to claim 2, wherein the plurality of terminal rows comprises at least one second terminal row, and partially adjacent terminals in the second terminal row are integrally connected at the left cut face and the right cut face, forming a ground plate.

4. The electrical connector according to claim 3, wherein two of the second terminal rows are arranged respectively at two opposite sides of the first terminal row in the second direction.

5. The electrical connector according to claim 1, wherein the lower resilient arm extends from a part of the lower cut face proximal to the left cut face and out of the lower face of the insulating housing, the lower resilient arm sequentially comprises a lower extending portion, a horizontal portion and a lower abutting portion, the lower extending portion extends downward from the lower cut face, the horizontal portion bends and extends in a horizontal direction from an end of the lower extending portion, the lower abutting portion extends upward from an end of the horizontal portion, and each of the terminals comprises a lower contact portion protruding downward from the horizontal portion.

6. The electrical connector according to claim 1, wherein the base portion has two first protruding ears formed by stamping, and the first protruding ears protrude in opposite directions from the metal faces of the base portion.

7. The electrical connector according to claim 6, wherein the base portion has two second protruding ears formed by stamping, the second protruding ears protrude in opposite directions from the metal faces of the base portion, and the second protruding ears are proximal to the lower cut face.

8. The electrical connector according to claim 1, wherein the upper abutting portion is positioned at an end of the horizontal portion, a free end of the upper abutting portion extends toward the extending portion, and when the upper resilient arm moves downward, the free end of the upper abutting portion abuts the upper cut face.

9. The electrical connector according to claim 1, wherein two of the ground plates arranged in two neighboring rows are connected through a plurality of grounding members.

10. The electrical connector according to claim 9, wherein each of the grounding members extends from one of the ground plates to and abuts the other ground plate of the neighboring row.

11. The electrical connector according to claim 9, wherein each of the ground plates has a plurality of through slots, the grounding members passes through the through slots respectively in the second direction and connects neighboring rows of the ground plates.

12. The electrical connector according to claim 9, wherein the grounding members are positioned in the second direction between neighboring rows of the ground plates and each comprise a main body and two resilient arms extending from the main body and respectively abutting the two of the ground plates.

13. An electrical connector comprising:
an insulating housing having an upper face, a lower face, and a long slot and a terminal slot passing through the upper face and the lower face;
at least one signal terminal row having a signal terminal and being arranged in a first direction, the signal terminal being fixed in the terminal slot; and
two ground terminal rows arranged at two sides of the signal terminal row and each having a plurality of ground terminals; wherein
each of the signal terminal and the ground terminals comprises an upright base portion, an upper resilient arm extending upward from the base portion and having an upper contact portion, and an upper abutting portion positioned at an end of the upper resilient arm for contacting the base portion, the ground terminals and the signal terminal have a same height in a vertical direction and each have an upper resilient arm, at least a portion of the ground terminals in the same row forms an integrated ground plate connecting respective base portions, and the integrated ground plate is positioned in the long slot.

14. The electrical connector according to claim 13, wherein the ground terminals and the signal terminal each have a lower resilient arm extending downward from the respective base portion and having a lower abutting portion, the lower resilient arm and the upper resilient arm are arranged symmetrical in the vertical direction, and a height of the ground terminals and the signal terminal is greater than or equal to 7 millimeters.

15. An electrical connector comprising:
at least two ground terminals being substantially parallel to each other and each having a base portion, a through slot formed at the base portion, and a contact portion arranged in the through slot;
at least one signal terminal substantially parallel to the ground terminals and arranged between the at least two ground terminals; and
a grounding member engaging the at least two ground terminals; wherein
the grounding member passes through the through slots of the at least two ground terminals and engages the at least two ground terminals by contacting the contact portions of the at least two ground terminals.

16. The electrical connector according to claim 15, wherein the grounding member passes through the signal terminal and is free of contact to the signal terminal.

17. The electrical connector according to claim 15, wherein the grounding member comprises a flat bar.

18. The electrical connector according to claim 15, wherein the base portion and the contact portion of each of the at least two ground terminals are substantially parallel to each other.

19. The electrical connector according to claim 15, wherein the contact portion of each of the at least two ground terminals comprises a resilient arm protruding into the through slot.

20. The electrical connector according to claim 15, wherein the contact portion of each of the at least two ground terminals comprises two clamp arms protruding into the through slot.
